(19) United States
(12) Patent Application Publication
(10) Pub. No.: US 2026/0065373 A1
(43) Pub. Date: Mar. 5, 2026

(54) HYBRID ASSET API GATEWAY FOR NETWORKED COMPUTING ENVIRONMENT

(71) Applicant: Orthoptera LLC, Sheridan, WY (US)

(72) Inventors: Vedad TAGAY, Wesel (DE); Erkan TAGAY, Wesel (DE); Berkan ATES, Dinslaken (DE)

(21) Appl. No.: 19/306,750

(22) Filed: Aug. 21, 2025

Related U.S. Application Data
(60) Provisional application No. 63/688,377, filed on Aug. 29, 2024.
(60) Provisional application No. 63/748,825, filed on Jan. 23, 2025.
(60) Provisional application No. 63/777,686, filed on Mar. 26, 2025.

(51) Int. Cl. G06Q 40/06; G06Q 20/36; H04L 9/06

(52) U.S. Cl. CPC G06Q 40/06; G06Q 20/36; H04L 9/0631; G06Q 2220/10; H04L 2209/56

(57) ABSTRACT

The present disclosure provides a hybrid asset API gateway system, comprising: a standardized application programming interface (API) gateway configured to integrate with issuer systems; a digital depot module configured to manage accounts, digital wallets, and fiat-based transaction records; a digital network module configured to create digital tokens representing ownership units of assets and to deploy such tokens on a distributed ledger network; and a digital register module configured to maintain immutable records of asset lifecycle events. The system allows an issuer to select between representing ownership units as traditional securities or blockchain-based digital tokens, wherein each ownership unit is backed on a one-to-one basis by the value of an underlying asset.

### CROSS-REFERENCE TO RELATED APPLICATIONS

This application claims priority to U.S. Provisional Application No. 63/688,377 filed on Aug. 29, 2024, U.S. Provisional Application No. 63/748,825 filed on Jan. 23, 2025, and U.S. Provisional Application No. 63/777,686 filed on Mar. 26, 2025, the entire disclosures of which are hereby incorporated herein by reference.

### FIELD OF INVENTION

The present disclosure relates to API gateways for networked computing systems, and more particularly to a hybrid asset API gateway infrastructure in a networked asset trading environment.

### BACKGROUND

Asset trading systems, such as securities trading systems for example, have evolved significantly over the past few decades, transitioning from manual floor-based trading to sophisticated electronic platforms. These systems typically incorporate order matching engines, real-time market data feeds, and risk management tools. As financial markets have become increasingly complex and globalized, trading systems have adapted to handle a wider range of asset classes, including traditional securities, derivatives, and more recently, digital assets.

Modern trading platforms often utilize distributed ledger technologies and smart contracts to facilitate transactions and automate various processes. These systems aim to improve liquidity, reduce settlement times, and enhance transparency in financial markets. For example, U.S. Pat. No. 11,410,235 discloses an apparatus and method for facilitating compliance and issuer governance in decentralized financial transactions. This approach aims to govern global financial transactions without the need for an active intermediary. U.S. Pat. No. 11,410,235 discloses a full trading platform that replaces conventional platforms. However, challenges remain in areas such as interoperability between different platforms, and the integration of traditional trading platforms and traditional financial instruments with emerging digital assets.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Current financial systems face significant limitations and inefficiencies that hinder broader market access and participation. High-value asset markets, such as hedge funds, real estate, and intellectual property, often remain inaccessible to many investors due to substantial capital modules and regulatory complexity. Meanwhile, digital asset solutions, while innovative, often lack integration with traditional financial systems, resulting in fragmented ecosystems that fail to meet the comprehensive needs of market participants. In addition, regulatory frameworks vary widely across jurisdictions, creating complexities that limit the scalability and universality of existing financial platforms.

These limitations underscore the pressing need for a flexible, inclusive, and secure technological infrastructure that enables issuers to provide improved investment access to a broader range of users. Such infrastructure must reduce the barriers to entry for smaller investors, enable seamless interoperability between traditional and digital asset representations, and support integration into existing asset issuer platforms. The Hybrid Asset API Gateway disclosed herein addresses these challenges by offering a unified and scalable B2B API solution that empowers issuers to fractionalize ownership, bridge asset formats, and deliver more accessible and efficient investment models—without disrupting their existing systems.

The disclosed implementations include a hybrid asset API gateway that enables issuers to represent ownership units as either traditional securities or digital tokens on a decentralized network (e.g., a blockchain network). This dual-representation model provides greater flexibility and allows for seamless integration with existing financial systems. Furthermore, the present invention incorporates a modular architecture. The modules can communicate with other systems, such as conventional asset trading systems and decentralized networks, through an application programming interface (API). This modular approach allows for independent deployment and upgrading of components, enhancing the system's adaptability to evolving market modules and regulatory landscapes. Additionally, the disclosed implementations facilitate interoperability by supporting multiple distributed ledger technologies and providing integration capabilities with third-party services, such as on- and off-ramp providers for cryptocurrency conversion. This feature addresses limitations in existing systems that may be restricted to specific blockchain platforms or lack seamless integration with traditional financial infrastructure. These advancements in the present invention aim to bridge the gap between traditional securities and digital assets, potentially enabling more efficient and accessible capital markets while maintaining regulatory compliance and operational flexibility.

According to an aspect of the present disclosure, a hybrid asset API gateway system is provided. The system includes a standardized API gateway configured to integrate with asset issuer systems and other systems. The system includes a digital depot module configured to manage asset accounts, digital wallets, and fiat-based transaction records. The system also includes a digital network module configured to create digital tokens representing ownership units of assets and to deploy such tokens on a distributed ledger network. The system further includes a digital register module configured to maintain immutable records of asset lifecycle events. The modules and the novel date model of the system allows an issuer to select between representing ownership units as traditional securities or blockchain-based digital tokens. Each ownership unit can be backed on a one-to-one basis by the value of an underlying asset.

According to other aspects of the present disclosure, the system may include one or more of the following features. The digital network module may be configured to interface with multiple distributed ledger technologies, and selection of a target blockchain network may be configurable by the issuer. The system may further comprise an integrated routing mechanism configured to transmit investor cryptocurrency payments to a third-party on- and off-ramp service provider for conversion into fiat currency, wherein the converted fiat may be programmatically credited to an issuer-designated settlement account. The digital network module may include a smart contract engine configured to enforce issuer-defined rules, including lock-up periods, transfer restrictions, and jurisdictional limitations. The digital register module may be operable to record all asset issuance events, ownership transfers, and corporate actions on a distributed ledger in an immutable and auditable format. Each module may be independently deployable and upgradable without affecting the functionality of the other modules. The standardized API gateway may expose endpoints for asset onboarding, ownership unit creation, representation selection, transaction execution, escrow management, and record retrieval.

According to another aspect of the present disclosure, a computer-implemented method for managing hybrid asset representations is provided. The method includes receiving, via an API gateway, an asset registration request from an issuer. The method includes creating, in response to the asset registration request, a digital representation of an asset. The method includes storing the digital representation in a digital depot module. The method includes receiving, via the API gateway, a request to issue ownership units of the asset. The method includes determining, based on issuer input, whether to represent the ownership units as traditional securities or blockchain-based digital tokens. The method further includes creating the ownership units in the selected representation format. The issuance of the ownership units can be in an immutable digital register.

According to other aspects of the present disclosure, the method may include one or more of the following features. The method may include receiving, via the API gateway, a request to transfer ownership units, verifying the transfer request against smart contract rules enforced by a digital network module and, upon successful verification, updating ownership records in the digital depot module and recording the transfer in the immutable digital register. The smart contract rules may include lock-up periods, transfer restrictions, and jurisdictional limitations configurable by the issuer. The method may include receiving, via the API gateway, a request to convert ownership units between traditional securities and blockchain-based digital tokens, and executing the conversion by updating representations in the digital depot module and recording the conversion event in the immutable digital register. Creating the ownership units in the selected representation format may comprise, for traditional securities, generating entries in a securities account within the digital depot module, and for blockchain-based digital tokens, deploying a token contract on a distributed ledger network via the digital network module. The method may include generating, based on data from the digital depot module and the immutable digital register, regulatory compliance reports, and providing the regulatory compliance reports to authorized parties via secure API endpoints.

According to another aspect of the present disclosure, a non-transitory computer-readable medium storing instructions is provided. When executed by a processor, the instructions cause the processor to perform operations for facilitating hybrid asset management in accordance with the method disclosed herein.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a block diagram of a hybrid asset API gateway architecture, according to aspects of the present disclosure.

FIG. 2 illustrates a microservices architecture overview according to aspects of the present disclosure.

FIG. 3 illustrates a system and message flow diagram according to aspects of the present disclosure.

FIG. 4 is a flow chart of a process for creating a hybrid asset.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Disclosed implementations are described herein in terms of software modules. As used herein, a software “module” is one or more units of code stored and/or executed on computer hardware. The code of a module can be a distinct and self-contained unit of software that performs a specific function within a larger system. However, the modules described herein are segregated in terms of function, for the sake of clear description, and thus the software units of a given module can be stored in multiple files at multiple locations. Modules can be thought of as building blocks that can be independently developed, tested, and maintained. Modules help in organizing code, making it easier to describe, manage, understand, and reuse. In the disclosed implementations functionalities are packaged into modules that can be reused across various services described herein. Each service/function can be a module that performs a specific function and communicates with other services.

The disclosed system provides a hybrid asset gateway having a modular infrastructure that can be interfaced to existing systems, and which enables issuers to fractionalize and represent ownership of diverse asset classes through a flexible framework. The system comprises multiple interconnected components that work together to facilitate the creation, management, and trading of both traditional securities and blockchain-based digital tokens. The system includes the standardized API gateway that serves as the primary integration point for issuer systems, allowing seamless communication and data exchange between external platforms and the internal modules of the system.

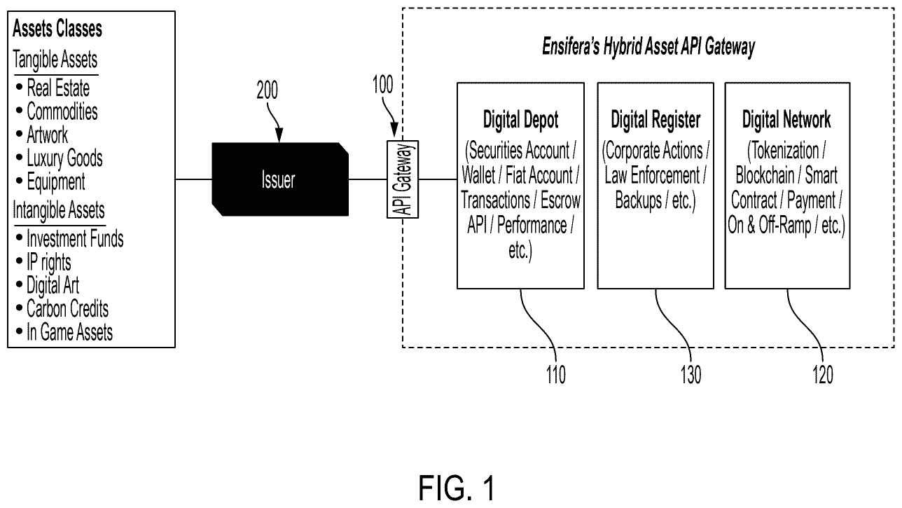

As illustrated in FIG. 1, a system in accordance with disclosed implementations includes a hybrid asset API gateway 100 which allows communication of the system modules with external systems (such as with asset issuer 200. The system also includes a digital depot module 110 which manages asset accounts, digital wallets, and fiat-based transaction records. This module can also handle the storage and processing of ownership units in the accounts, regardless of their representation format, and may maintain balances, process transfers, and manage escrow functionalities.

A digital network module 120 enables the creation of digital tokens that represent ownership units of assets (i.e., tokenization of assets). This module can also handle the deployment of these tokens on distributed ledger networks, providing the necessary infrastructure for blockchain-based asset representation, and manages interactions with various blockchain platforms.

To maintain a comprehensive and immutable record of all asset-related events, the system includes a digital register module 130. This module records and stores lifecycle events associated with assets and their ownership units, ensuring a transparent and auditable history. The digital register module 130 maintains immutable records of asset lifecycle events. This module records and stores issuance events, ownership transfers, and corporate actions, ensuring a transparent and auditable history of all asset-related activities.

The system allows issuers to select between representing ownership units as traditional securities or digital tokens on a decentralized network. This flexibility enables asset issuers to satisfy various investor preferences and regulatory frameworks while maintaining a unified backend infrastructure. As described in more detail below, each ownership unit, whether represented as a traditional security or a digital token, can be backed on a one-to-one basis by the value of an underlying asset. This ensures that the digital representations accurately reflect the true value of the assets they represent, maintaining integrity and trust in the fractional ownership model.

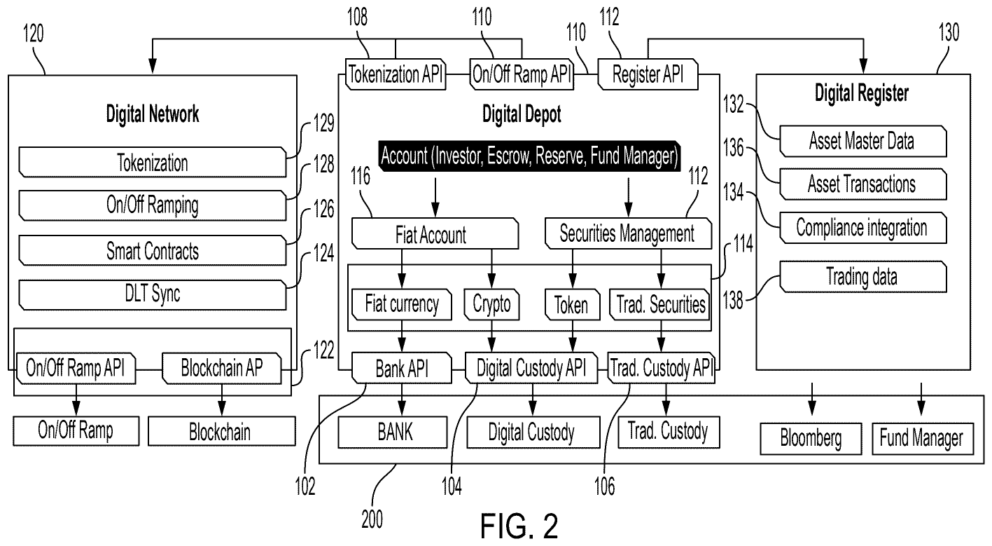

FIG. 2 illustrates the function of the digital depot module 110, the digital network module 120 and the digital register module 130 in greater detail. The system can integrate the multiple modules to enable asset fractionalization, dual-format representation, and lifecycle management. These components work together to facilitate seamless operations across various stages of asset handling and transaction processing. In FIG. 2, API gateway 100 is shown as constituent components bank API 102, Digital Custody/Wallet API, 104, traditional custody API 106, tokenization API 108, on/off ramp API 110, and register API 112 (all which provide APIs to the elements shown in FIG. 2 and otherwise discussed herein). API gateway 100 also includes APIs associated with integrated routing module 122 discussed below.

An asset registration request can be received from an issuer 200 through the API gateway 100. Upon receipt of this request, the system may create a digital representation of the asset and store this representation in asset register module 114 of the digital depot module 110. This digital representation may serve as the foundation for subsequent asset management and transaction processes within the system.

Note that asset the register module 114 can store fiat currency records and cryptocurrency records in connection with a fiat account and can store cryptographic tokens and traditional securities information in association with a securities management account. The asset register module includes a transactional ledger. It does not necessarily hold static account or wallet balances. Instead, it records every asset-related event as an immutable transaction. These events include actions such as issuance, transfer, conversion, escrow release, and corporate actions. Each transaction reflects a change in ownership or status of an asset unit and is linked to a specific asset identifier, the involved source and target accounts or wallets, the quantity moved, the representation type (traditional security or token), and a timestamp. Additional metadata may include jurisdictional information, smart contract IDs, or compliance flags.

Balances for accounts or wallets are computed on demand by aggregating historical transactions-similar to how blockchain-based ledgers derive ownership. This approach ensures that all balances are fully auditable and backed by verifiable events. By avoiding direct balance storage, the system ensures traceability, transparency, and regulatory integrity.

The asset register module 114 also provides lifecycle tracking. It captures each state change and provides an immutable audit trail that supports compliance checks, regulatory reporting, and integration with downstream services such as custodians, compliance engines, or blockchain synchronization modules. Through this event-driven architecture, the asset register module 114 provides a reliable, tamper-proof source of truth for all asset ownership and movement within the Hybrid Asset API Gateway.

The system may also receive requests to issue ownership units of registered assets via the API gateway 100. In response to such requests, the system may determine whether to represent the ownership units as traditional securities or blockchain-based digital tokens. This determination may be based on input provided by the issuer. The flexibility to choose between these representation formats allows the system to cater to diverse issuer preferences and regulatory modules.

In some implementations, when creating ownership units as traditional securities, the system may generate entries in a securities account within asset register module 114. Alternatively, for blockchain-based digital tokens, the process may involve deploying a token contract on a distributed ledger network via the digital network module 120. The distributed ledger network used for token deployment may be selectable by the issuer from multiple supported blockchain technologies, providing additional flexibility in token issuance.

The system may record the issuance of ownership units in an immutable digital register, such as a blockchain or other decentralized network/ledger. This recording process ensures a transparent and auditable trail of all asset-related activities, supporting regulatory compliance and providing a reliable historical record.

Digital network module 120 can include an integrated routing module 122 (including an on/off ramp API and a blockchain API) for handling investor cryptocurrency payments. Routing module 122 may transmit such payments to a third-party on- and off-ramp service provider for conversion into fiat currency. Following the conversion process, the resulting fiat currency may be programmatically credited to an issuer-designated settlement account. This functionality may enable seamless integration of cryptocurrency payments into the traditional financial infrastructure.

The system may also receive requests to convert ownership units between traditional securities and blockchain-based digital tokens via the API gateway 100. In response to such requests, the system may execute the conversion by updating representations in the digital depot module 110. The system may also record the conversion event in the immutable digital register, maintaining a comprehensive record of all changes in asset representation.

Throughout these processes, the various modules of the system may interact continuously, exchanging data and coordinating actions to ensure smooth operation and maintain system integrity. The API gateway 100 may serve as the central point of interaction for external systems and users, while the internal modules handle specific aspects of asset management, transaction processing, and record-keeping.

As described above, the digital depot module 110 manages the storage and tracking of asset representations and ownership records, the digital network module 120 handles interactions with blockchain networks and smart contract management, and the digital register module manages market asset data, such as asset metadata, transaction data, regulatory enforcement data, and market trading data. By integrating these components and functionalities, the system provide a flexible hybrid asset gateway and robust infrastructure for managing the lifecycle of fractionalized assets in both traditional and tokenized formats.

The API gateway 100 exposes a set of endpoints that allow issuers to interact with various functionalities of the system. Each module within the Hybrid Asset API Gateway system may be independently deployable and upgradable. This modular design allows for flexibility in system maintenance and enhancement. Upgrades or modifications to one module may be performed without affecting the functionality of the other modules.

The standardized API gateway 100 may be configured to integrate with various issuer systems. This configuration allows for adaptability to different technological environments and business modules. Issuers may interact with the system through well-defined API endpoints, enabling seamless integration with their existing platforms and workflows. The modular and API-first architecture of the system provides a flexible and scalable infrastructure for managing hybrid asset representations. This design approach allows for efficient system maintenance, feature enhancements, and integration capabilities while maintaining the integrity and functionality of the overall system.

The digital depot module 110 may implement various functions as additional modules therein. An account support module 116 allows for the creation and maintenance of fiat and cryptocurrency accounts. This functionality may include support for deposit and withdrawal operations across various currency types. A securities management module 112 manages traditional and tokenized securities in digital wallets, which enables the handling of both traditional securities and tokenized assets within a unified infrastructure.

Further, an escrow module may be implemented within the digital depot module 110 to provide secure holding and release mechanisms for assets during complex transactions or conditional agreements. The escrow functionality may support various escrow scenarios, including time-based releases and multi-party approvals. A settlement module can support T+0 settlement and atomic delivery-versus-payment (DvP) for tokenized assets. This capability may enable near-instantaneous settlement of transactions, reducing counterparty risk and improving liquidity. A lifecycle rules module allows for the implementation of asset-specific rules and restrictions. These rules may govern aspects such as transfer limitations, lock-up periods, and other constraints on asset movement or ownership changes. An account exposure module can provide mechanisms for exposing account balances, transaction histories, and other relevant data through standardized API interfaces. This module may enable authorized parties to retrieve account information programmatically, facilitating integration with external systems and reporting tools.

The architecture of the digital depot module 110 can provide for flexible configuration and customization to meet diverse issuer modules and regulatory frameworks. By combining these various modules and functionalities, the digital depot module 110 serves as a comprehensive solution for managing the lifecycle of both traditional and tokenized assets within the Hybrid Asset API Gateway system.

As noted above, the digital network module 120 is configured to create (e.g., mint) and manage digital tokens representing ownership units of assets. The digital network module 120 may include a token minting module 129 for creating digital tokens that represent fractional ownership of assets. These tokens may be issued on various distributed ledger networks, providing flexibility in token deployment. The digital network module 120 may also incorporate a smart contract manager 126 that handles the deployment and management of smart contracts on selected blockchain networks. These smart contracts may encode the rules and logic governing the behavior of the digital tokens.

The digital network module 120 may also include a ramp integration module 128 to facilitate the conversion between cryptocurrencies and fiat currencies, enabling seamless on-ramps and off-ramps for investors participating in token offerings. In some cases, the digital network module 120 may incorporate a reserve mechanism module configured to ensure that tokenized securities are backed by corresponding assets, maintaining the integrity of the tokenization process.

The digital network module 120 may be designed to interface with multiple distributed ledger technologies. This capability allows the system to support various blockchain platforms, providing flexibility for issuers in selecting the most suitable network for their token deployments. In some implementations, the selection of a target blockchain network may be configurable by the issuer. This feature allows issuers to choose the blockchain that best aligns with their specific modules, such as transaction speed, cost, or regulatory compliance.

The digital network module 120 may work in conjunction with other components of the Hybrid Asset API Gateway system. For example, the digital network module 120 may interact with the securities management module of the digital depot module 110 to ensure proper representation of tokenized assets. In some cases, the transaction processing module may be leveraged by the digital network module 120 to handle token transfers and settlements. The escrow module may be integrated with smart contract functionality to facilitate secure token transactions.

The settlement module may be supported by the ability of the digital network module 120 to execute near-instantaneous settlements on blockchain networks. The lifecycle rules module may be implemented through smart contracts deployed by the digital network module 120. The account exposure module may be extended to include token balances and transaction histories, providing a comprehensive view of both traditional and tokenized assets within the system. By combining these various components and functionalities, the digital network module 120 enables the system to support the creation, management, and trading of blockchain-based digital tokens representing fractional ownership of diverse asset classes. The digital network module 120 may include a DLT sync module 124 for optional synchronization with various distributed ledger technologies. This capability may allow the digital register module 130 to maintain consistency with blockchain-based records, enhancing the overall integrity and verifiability of the system's data.

The digital register module 130, which is configured to maintain immutable records of asset lifecycle events, ensures transparency, auditability, and regulatory compliance within the system. In some cases, the digital register module 130 may include a record keeper module 132 for recording and storing all asset issuance events, ownership transfers, and corporate actions. These records may be maintained on a distributed ledger, providing a tamper-resistant and verifiable history of asset-related activities.

The digital register module 130 may incorporate a compliance register module 134 to handle the registration and tracking of regulatory compliance events, corporate actions, and other legally significant occurrences throughout an asset's lifecycle. This functionality may support issuers in meeting regulatory reporting modules and maintaining accurate compliance records. The digital register module 130 may also feature an audit log generator for creating detailed, immutable audit trails of all significant events and actions within the system. These audit logs may provide a comprehensive record for internal reviews, external audits, and regulatory inspections.

The digital register module 130 may work in conjunction with other components of the Hybrid Asset API Gateway system. For example, the digital register module 130 may interact with the securities management module of the digital depot module 110 to record changes in ownership of both traditional and tokenized assets. The account support module may be utilized to track account-level events and changes.

In some cases, the transaction processing module may be leveraged by the digital register module 130 to capture detailed records of asset transfers and settlements. The escrow module may be integrated with the digital register to maintain auditable records of escrow arrangements and releases. The settlement module may be supported by the ability of digital register module to record near-instantaneous settlements, providing a real-time audit trail of transaction completions. The lifecycle rules module may be reflected in the digital register's records, capturing the enforcement of asset-specific rules and restrictions. The account exposure module may be extended to include access to historical records and audit trails, allowing authorized parties to retrieve comprehensive asset and transaction histories through standardized API interfaces.

The digital register module 130 may also interact with components of the digital network module 120. For instance, the token minting module may trigger record creation in the digital register for new token issuances. The smart contract manager module may provide data on smart contract deployments and updates for inclusion in the immutable record. In some implementations, the lifecycle rules module may feed information on rule enforcement events to the digital register for auditing purposes. The ramp integration module may generate records of cryptocurrency-to-fiat conversions, which may be captured by the digital register for comprehensive transaction tracking. The reserve mechanism module may provide data on asset backing status, which may be recorded by the digital register to maintain transparency on the relationship between tokenized securities and their underlying assets.

By combining these various components and functionalities, the digital register module 130 enables the system to maintain a comprehensive, immutable, and auditable record of all asset-related events and actions. This capability supports regulatory compliance, enhances transparency, and provides a reliable source of truth for the entire system. The system can specify an API and integration module that provides a standardized interface for external systems and third-party integrations. This module facilitates seamless communication and data exchange between the core components of the system and external platforms by, for example, exposing RESTful APIs for all core functions of the system. These APIs may provide standardized endpoints for various operations, including asset onboarding, ownership unit creation, representation selection, transaction execution, escrow management, and record retrieval.

The system may incorporate an authentication enforcement module configured to handle the implementation of, for example, OAuth2-based authentication and role-based access control (RBAC) for all API endpoints. This module may ensure that only authorized users and systems can access the exposed functionalities.

In some implementations, the system may include a rate limiting module for applying rate limiting and tenant isolation on API usage. This functionality may help prevent abuse of the system and ensure fair resource allocation among different tenants or users. A webhook module can be configured to support webhook integration for event notifications. This capability may allow external systems to receive real-time updates on specific events or changes within the Hybrid Asset API Gateway system.

The API gateway 100 may work in conjunction with other components of the Hybrid Asset API Gateway system. For example, the API Gateway may interact with the securities management module of the digital depot module 110 to expose endpoints for managing both traditional and tokenized assets. The account support module may be utilized to provide API access for account-related operations. The transaction processing module may be leveraged by the API gateway 100 and to expose endpoints for executing and monitoring financial transactions. The escrow module may be integrated with the API gateway 100 to allow programmatic management of escrow arrangements.

The settlement module may be supported by API endpoints that enable near-instantaneous settlement initiation and status tracking. The lifecycle rules module may be reflected in API functionalities that allow configuration and enforcement of asset-specific rules and restrictions. The account exposure module may be extended through the API gateway 100, providing standardized interfaces for retrieving account information, balances, and transaction histories.

The API gateway 100 may also interact with components of the digital network module 120. For instance, the token minting module may be accessible through API endpoints for initiating token creation processes. The smart contract manager module may expose interfaces for deploying and managing smart contracts via the API gateway 100. Similarly, the lifecycle rules module may be configurable through API endpoints of API gateway 100, allowing issuers to define and update rules programmatically and the ramp integration module may provide API access for initiating and monitoring cryptocurrency-to-fiat conversions. The reserve mechanism module may expose API endpoints through API gateway 100 for querying and managing asset backing status, enhancing transparency and auditability.

The API gateway 100 may also facilitate interaction with the digital register module 130, and the record keeper module for retrieving historical records of asset-related events. The API gateway 100 can serve to expose interfaces for the compliance register module (for querying and updating compliance-related information), the DLT sync module (for monitoring and managing synchronization with distributed ledger technologies) and the audit log generator (for retrieving detailed audit trails and generating compliance reports).

By combining these various components and functionalities, the API gateway 100 enables the system to provide a comprehensive and flexible interface for external systems and third-party integrations. This standardized API structure supports seamless integration with diverse platforms and workflows, enhancing the overall utility and adaptability of the system.

The system can incorporate a user and compliance module that manages user identities, access control, and regulatory compliance within the platform. The user and compliance module manages user identities, roles, access control, and regulatory compliance within the system. The user and compliance module may communicate with authentication module 140 to handle user authentication (via OAuth 2.0 for example) or may utilize external identity providers. In some implementations, the User and compliance module may include an onboarding module for managing jurisdiction-specific onboarding processes for both individuals and businesses. This functionality may support compliance with diverse regulatory frameworks across different regions.

The user and compliance module may also feature a “Know Your Customer” (KYC) integration module. The KYC integration module may facilitate integration with KYC provider services. This capability may enable the system to perform thorough identity verification and due diligence checks on users before allowing them to participate in asset-related activities. In some cases, the user and compliance module may incorporate a sanctions screening module. The sanctions screening module can handle sanction list checks and Politically Exposed Person (PEP) screenings. This module may help ensure compliance with international regulations and reduce the risk of illicit activities within the system.

The authentication module may be utilized by the rate limiting module to enforce user-specific usage limits. The onboarding module may be integrated with the securities management module to ensure proper user verification before allowing access to asset management functionalities. The KYC integration module can work in cooperation with the account support module to facilitate compliant account creation processes.

The sanctions screening module may be leveraged by the transaction processing module to perform real-time checks before executing financial transactions. The escrow module may utilize compliance data from the user and compliance module to enforce jurisdiction-specific escrow rules. The settlement module may incorporate compliance checks from the user and compliance module to ensure regulatory alignment during settlement processes. The lifecycle rules module may reference user compliance status when enforcing asset-specific rules and restrictions.

The User and compliance module may also interact with components of the digital network module 120. For instance, the token minting module may consult user compliance data before initiating token creation processes. The smart contract manager may incorporate compliance-related logic based on user attributes and jurisdictional modules. The lifecycle rules module may utilize compliance data from the User and compliance module to enforce user-specific transfer restrictions or lock-up periods. The ramp integration module may perform additional compliance checks during cryptocurrency-to-fiat conversions based on user profiles.

The User and compliance module may provide compliance-related data to the digital register module 130. The record keeper module may incorporate user compliance events into the immutable record of asset-related activities. The compliance register module may utilize data from the User and compliance module to maintain comprehensive compliance records. In some cases, the DLT sync module may include user compliance status when synchronizing data with distributed ledger technologies. The audit log generator may incorporate user compliance events and checks into the detailed audit trails generated by the system.

The user and compliance module may integrate with third-party compliance service providers to enhance its capabilities. This integration may allow the system to leverage specialized compliance tools and databases, further strengthening the overall compliance framework. The user and compliance module may facilitate Know Your Customer (KYC) and Anti-Money Laundering (AML) checks for investors prior to issuing ownership units. This process may involve verifying user identities, assessing risk profiles, and ensuring compliance with relevant regulations before allowing participation in asset offerings or transactions. By combining these various components and functionalities, the User and compliance module enables the system to maintain a robust compliance framework. This module supports secure user management, regulatory alignment, and risk mitigation across the platform's operations.

The system can also include a trading module that manages order submission, matching, and settlement processes for over-the-counter (OTC) trading activities. The trading module may include an order submission interface for handling the submission of buy and sell orders from investors. This interface may provide a standardized method for users to input their trading intentions, including asset selection, order type, quantity, and price parameters. The trading module may incorporate an order matching module configured to process and match orders based on predefined criteria and issuer-specific logic. This module may analyze incoming orders, identify potential matches, and execute trades when compatible buy and sell orders are found. In some implementations, the Trading Module may include a settlement forwarding module for directing matched trades to the appropriate settlement systems within the system. This module may ensure that the necessary information and instructions are transmitted to initiate the settlement process.

The trading module may work in conjunction with other components of the system. For example, the order submission module may interact with the user type module to enforce role-based access controls for trading activities. The authentication module may be utilized to verify user identities before allowing order submissions. In some cases, the onboarding module may be leveraged by the trading module to ensure that users have completed necessary registration steps before participating in trading activities. The KYC integration module and the sanctions screening module may be queried to perform compliance checks on users before processing their orders.

The Trading Module may utilize the API exposure module to provide standardized endpoints for order submission and trade status inquiries. The authentication enforcement module may be applied to secure these trading-related API endpoints. The rate limiting module may be implemented to prevent abuse of the trading system and ensure fair access for all users. The webhook module may be used by the Trading Module to provide real-time notifications of order status changes or trade executions to external systems or user interfaces.

The trading module may also interface with the securities management module of the digital depot module 110 to ensure proper handling of both traditional and tokenized assets during the trading process. The account support module may be utilized to verify available balances and manage account updates resulting from trades. The transaction processing module may be leveraged by the trading module to execute the financial aspects of completed trades. The escrow module may be integrated with the trading process to handle conditional trades or time-based releases of assets. The settlement module may be directly invoked by the settlement forwarding module to initiate the settlement process for matched trades. The lifecycle rules module may be consulted by the order matching module to ensure compliance with asset-specific trading restrictions or limitations. The account exposure module may be utilized by the Trading Module to provide users with up-to-date information on their trading activities and resulting account balances.

The Trading Module may also interact with components of the digital network module 120. For instance, the token minting module may be notified of trading activities that result in new token issuances. The smart contract manager may be consulted to ensure that trades comply with any smart contract-based rules or restrictions. In some implementations, the lifecycle rules module may provide input to the order matching module to enforce trading-related rules encoded in smart contracts. The ramp integration module may be utilized if trades involve conversions between cryptocurrencies and fiat currencies. The reserve mechanism module may be updated based on trading activities to maintain proper backing of tokenized securities.

The Trading Module may provide data to the digital register module 130 for record-keeping purposes. The record keeper module may capture details of all trading activities, including order submissions, matches, and settlements. The compliance register module may record trading-related compliance events and checks. In some cases, the DLT sync module may be notified of trades involving blockchain-based assets to ensure proper synchronization with distributed ledger technologies. The audit log generator may create detailed audit trails of all trading activities, supporting regulatory compliance and internal reviews.

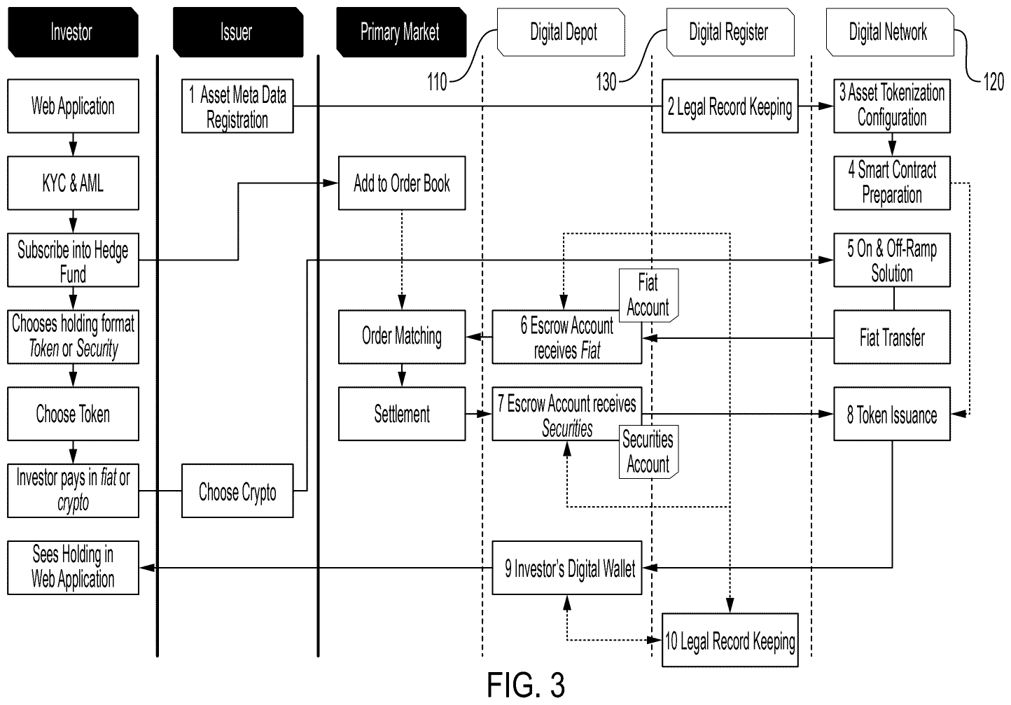

Digital register 130 includes an asset data module 132 (FIG. 3) that stores and manages asset information, including registration, valuation, and market data integration. This module plays a role in handling diverse asset classes and maintaining comprehensive asset data within the system. In some cases, the asset data module 132 may include an asset registration module responsible for onboarding new assets into the system. This module may handle the input and storage of asset metadata, including asset type, issuer information, and relevant documentation.

The Asset data module 132 may incorporate a market data integrator which facilitates connections with external market intelligence providers. This component may enable the system to retrieve and incorporate real-time market data, enhancing the accuracy of asset valuations and pricing information. The Asset data module 132 may further include a valuation processor for handling Net Asset Value (NAV) calculations and processing valuation reports for various asset types. This module may support both automated and manual valuation inputs, depending on the asset class and available data sources. The Asset data module 132 may also feature a data exposure module for providing historical and live asset data through standardized interfaces. This module may enable authorized users and systems to access comprehensive asset information, including pricing history, performance metrics, and current valuations.

The Asset data module 132 may work in conjunction with other components of the system. For example, the asset registration module may interact with the user type module to enforce role-based access controls for asset registration processes. The authentication module may be utilized to verify user identities before allowing asset data modifications. The onboarding module may be leveraged by the asset data module 132 to ensure that asset registration aligns with jurisdiction-specific modules. The KYC integration module and the sanctions screening module may be queried to perform compliance checks on asset issuers or related parties.

The Asset data module 132 may utilize the API exposure module to provide standardized endpoints for asset data retrieval and management. The authentication enforcement module may be applied to secure these asset-related API endpoints. The rate limiting module may be implemented to prevent excessive data requests and ensure system stability. The webhook module may be used by the Asset data module 132 to provide real-time notifications of significant asset data updates or valuation changes to external systems or user interfaces.

The Asset data module 132 may interface closely with the securities management module 112 of the digital depot module 110 to ensure proper representation of asset data for both traditional securities and tokenized assets. The account support module may be utilized to associate asset holdings with specific user accounts. The transaction processing module may leverage asset data from this module to execute accurate financial transactions. The escrow module may utilize asset valuation data for escrow calculations and releases.

The settlement module may query the Asset data module 132 for current asset valuations during settlement processes. The lifecycle rules module may reference asset-specific data when enforcing rules and restrictions. The account exposure module may utilize data from the Asset data module 132 to provide users with comprehensive views of their asset holdings and performance.

The Asset data module 132 may also interact with components of the digital network module 120. For instance, the token minting module may consult asset data when creating digital representations of assets. The smart contract manager may incorporate asset-specific parameters into deployed smart contracts.

In some implementations, the lifecycle rules module may utilize asset data to enforce asset-specific transfer restrictions or distribution rules. The ramp integration module may reference asset valuations during cryptocurrency-to-fiat conversions related to asset transactions. The reserve mechanism module may use asset data to maintain proper backing ratios for tokenized securities. The Asset data module 132 may provide data to the digital register module 130 for record-keeping purposes. The record keeper module may capture details of asset registrations, valuation updates, and other significant asset-related events. The compliance register module may record compliance checks and verifications related to asset data.

In some cases, the DLT sync module may be notified of asset data updates to ensure proper synchronization with distributed ledger technologies. The audit log generator may create detailed audit trails of all asset data modifications and access events, supporting regulatory compliance and internal reviews. The Asset data module 132 may interact with the Trading Module to support trading activities. The order submission interface may utilize current asset data when processing trade orders. The order matching module may reference asset valuations and characteristics during the matching process. In some implementations, the settlement forwarding module may consult the Asset data module 132 for final asset valuations before initiating settlement processes.

By combining these various components and functionalities, the Asset data module 132 enables the system to maintain comprehensive and up-to-date asset information, supporting accurate valuations, informed decision-making, and compliant asset management across the platform.

The system can incorporate a reporting module that manages the generation and distribution of various reports within the platform. This module plays a crucial role in ensuring regulatory compliance, providing investor disclosures, and supporting custom reporting needs. In some cases, the reporting module may include a regulatory report generator for creating predefined regulatory reports based on data aggregated from multiple system components. This module may compile information from the digital depot module 110 and the immutable digital register to produce comprehensive compliance reports.

The reporting module may incorporate a scheduled report module to handle the automated generation of reports on predefined schedules or in response to specific triggers. This functionality may support periodic reporting modules and ensure timely delivery of important information. The reporting module may include a disclosure generator for producing investor-level disclosures, such as tax reports or dividend distribution statements. This module may utilize account-specific data to generate personalized reports for individual investors. The reporting module may also feature a custom report module. A custom report module may support the creation of tailored reports based on user-defined parameters and data selection criteria. This capability may allow authorized users to generate specialized reports for specific business needs or ad-hoc analysis.

The reporting module may work in conjunction with other components of the Hybrid Asset API Gateway system. For example, the regulatory report generator may interact with the user type module to enforce role-based access controls for report generation and viewing. The authentication module may be utilized to verify user identities before allowing access to sensitive report data. The onboarding module may be leveraged by the reporting module to ensure that generated reports comply with jurisdiction-specific modules. The KYC integration module and the sanctions screening module may provide input for compliance-related reporting.

The reporting module may utilize the API exposure module to provide standardized endpoints for report retrieval and management. The authentication enforcement module may be applied to secure these reporting-related API endpoints. The rate limiting module may be implemented to prevent excessive report generation requests and ensure system stability. The webhook module may be used by the reporting module to provide notifications when scheduled reports are completed or when critical regulatory reports are generated. The reporting module may interface with the securities management module 112 of the digital depot module 110 to access comprehensive data on both traditional securities and tokenized assets for reporting purposes. The account support module may be utilized to retrieve account-level data for investor-specific reports.

The transaction processing module may provide transaction data for inclusion in various reports. The escrow module may supply information on escrow arrangements and releases for regulatory reporting. In some cases, the settlement module may provide settlement data for transaction-related reports. The lifecycle rules module may be consulted to ensure that generated reports reflect current asset-specific rules and restrictions. The account exposure module may be leveraged by the reporting module to access detailed account information for comprehensive reporting.

The reporting module may also interact with components of the digital network module 120. For instance, the token minting module may provide data on token issuances for inclusion in regulatory reports. The smart contract manager may supply information on deployed smart contracts and their parameters for compliance reporting. The lifecycle rules module may provide input on rule enforcement events for inclusion in regulatory and custom reports. The ramp integration module may supply data on cryptocurrency-to-fiat conversions for transaction reporting. The reserve mechanism module may provide information on asset backing status for inclusion in regulatory and investor disclosure reports.

The reporting module may closely integrate with the digital register module 130. The record keeper module may serve as a primary data source for many reports, providing comprehensive historical records of asset-related events. The compliance register module may supply critical data for regulatory compliance reports. In some cases, the DLT sync module may provide information on blockchain synchronization status for reports related to tokenized assets. The audit log generator may be a key data source for detailed audit reports and compliance verifications.

The reporting module may incorporate data from the trading module to support comprehensive reporting. The order submission interface, order matching module, and settlement forwarding module may provide trading-related data for inclusion in various reports. The reporting module may leverage data from the asset data module 132 to enhance report content. The asset registration module may provide foundational asset information for regulatory and custom reports. The market data integrator and valuation processor may supply current and historical asset valuation data for performance reporting. The data exposure module may be utilized by the reporting module to access comprehensive asset data for inclusion in generated reports.

By combining these various components and functionalities, the reporting module enables the system to generate comprehensive, compliant, and customizable reports. These reports may be made available to authorized parties through secure API endpoints, supporting regulatory compliance, investor communication, and informed decision-making across the platform.

The system can incorporate comprehensive security and compliance features to ensure data integrity, regulatory alignment, and secure operations across the platform. These features are integrated throughout the system's architecture and operational processes. The system may include an authentication module. An authentication module may enforce OAuth 2.0 authentication and role-based access control on all API endpoints. This module may work in conjunction with the authentication enforcement module to provide a robust authentication framework for the entire system. The system may incorporate an encryption module. An encryption module may specify that all data in transit and at rest is encrypted using AES-256 or equivalent encryption standards. This module may help protect sensitive information from unauthorized access or interception.

Digital register 130 can include a compliance integration module 134 that facilitates integration with external compliance systems, services, or modules via secure plugin or webhook interfaces. This module may enable the system to adapt to diverse regulatory frameworks and compliance needs across different jurisdictions.

The system may also feature an audit module to ensure that all administrative actions are logged and audit trails are exposed. This module may support transparency, accountability, and regulatory compliance by maintaining comprehensive records of system activities. The user type module may interact with these security and compliance features to enforce differentiated access controls based on user roles.

In some cases, the onboarding module may utilize the compliance integration module 134 to ensure that user onboarding processes align with jurisdiction-specific regulatory modules. The KYC integration module and the sanctions screening module may leverage these compliance features to perform thorough identity verification and risk assessment.

The API gateway may leverage the encryption module to provide secure API communications. The rate limiting module may work in conjunction with the authentication module to prevent abuse and ensure fair resource allocation. The webhook module may utilize the encryption module to secure event notifications sent to external systems. The securities management module 112 may leverage the compliance integration module 134 to ensure regulatory alignment in asset management processes.

In some implementations, the account support module may incorporate the audit module to maintain detailed records of account-related activities. The transaction processing module may utilize the encryption module to secure financial transactions. The escrow module may leverage the compliance integration module 134 to ensure that escrow arrangements comply with relevant regulations. The settlement module may incorporate the audit module to maintain comprehensive settlement records.

The lifecycle rules module may utilize the compliance integration module 134 to implement and enforce issuer-configurable rules, including lock-up periods, transfer restrictions, and jurisdictional limitations. These rules may be encoded within smart contracts managed by the smart contract manager. The ramp integration module may leverage the authentication module and the encryption module to secure cryptocurrency-to-fiat conversion processes. The reserve mechanism module may incorporate the audit module to maintain transparent records of asset backing. The record keeper module may utilize the encryption module to secure stored records and the audit module to maintain comprehensive audit trails.

The DLT sync module 124 can leverage the encryption module to secure data synchronization with distributed ledger technologies. An audit log generator may work in conjunction with the audit module to produce detailed, tamper-resistant audit logs. In some implementations, an order submission interface and the order matching module may leverage the authentication module and the encryption module to secure trading processes. A settlement forwarding module may leverage the audit module to maintain comprehensive settlement records.

The asset registration module may utilize the compliance integration module 134 to ensure that asset onboarding processes align with regulatory requirements. The market data integrator and the valuation processor may incorporate the encryption module to secure external data integrations and valuation processes. The data exposure module may leverage the authentication module and the encryption module to secure access to asset data. The regulatory report generator may utilize the compliance integration module 134 and the audit module to produce comprehensive compliance reports. A scheduled report module and the disclosure generator may incorporate the encryption module to secure report generation and distribution processes. The custom report module may leverage the authentication module to ensure that only authorized users can generate custom reports.

The system incorporates various features and architectural design principles to ensure scalability, high performance, and robust availability. These considerations are integrated throughout the system's components and operational processes. The system may include a response time module that requires that APIs respond within a predetermined time (e.g., 500 ms for 95% of requests under normal load conditions). This module may help ensure responsive user experiences and efficient system interactions. The system may incorporate a concurrent request module to require that the system handles a minimum of 1,000 concurrent requests. This capability may support high-volume trading activities and simultaneous user interactions without degradation in performance.

A scaling module may support horizontal scaling in Kubernetes. This capability allows the system to dynamically adjust resources based on demand, ensuring optimal performance during peak usage periods. The API gateway module 100 may leverage the scaling module to maintain consistent API performance under varying load conditions. The authentication enforcement module may utilize the concurrent request module to ensure efficient processing of authentication requests during high-volume periods. In some cases, the rate limiting module may work in conjunction with the scaling module to prevent system overload while allowing for increased capacity when needed. The webhook module may leverage the response time module to ensure timely delivery of event notifications to external systems.

The securities management module 112 may utilize the scaling module to handle large volumes of asset-related operations efficiently. The account support module may leverage the concurrent request module to manage multiple simultaneous account interactions. The transaction processing module may incorporate the response time module to ensure swift execution of financial transactions. The escrow module may utilize the scaling module to manage multiple escrow arrangements concurrently.

In some implementations, the settlement module may leverage the concurrent request module to process multiple settlements simultaneously. The lifecycle rules module may utilize the scaling module to enforce rules across a large number of assets efficiently. The account exposure module may incorporate the response time module to provide rapid access to account information. The token minting module may leverage the scaling module to handle high-volume token creation processes.

The smart contract manager may utilize the concurrent request module to manage multiple smart contract interactions simultaneously. The lifecycle rules module may incorporate the scaling module to enforce rules across a growing number of tokenized assets. The ramp integration module may leverage the response time module to ensure swift cryptocurrency-to-fiat conversions. The reserve mechanism module may utilize the scaling module to maintain proper backing ratios across a large number of tokenized securities. The record keeper module may incorporate the concurrent request module to handle multiple record creation and retrieval operations simultaneously. The compliance register module may leverage the scaling module to manage compliance records for a growing number of assets and transactions.

The DLT sync module may utilize the response time module to ensure timely synchronization with distributed ledger technologies. The audit log generator may incorporate the scaling module to handle the creation and storage of audit logs for a high volume of system events. The order submission interface may leverage the concurrent request module to handle multiple simultaneous order submissions. The order matching module may utilize the scaling module to efficiently process and match orders during high-volume trading periods.

The settlement forwarding module may incorporate the response time module to ensure swift initiation of settlement processes. The asset registration module may leverage the scaling module to handle the onboarding of multiple assets concurrently. The market data integrator may utilize the concurrent request module to manage multiple simultaneous data feeds from external providers. The valuation processor may incorporate the scaling module to handle valuation calculations for a large number of assets efficiently.

In some cases, the data exposure module may leverage the response time module to provide rapid access to asset data. The regulatory report generator may utilize the scaling module to efficiently generate reports for a growing number of assets and transactions. The scheduled report module may incorporate the concurrent request module to manage multiple report generation processes simultaneously. The disclosure generator may leverage the scaling module to handle the creation of disclosures for a large number of investors efficiently. The custom report module may utilize the response time module to ensure swift generation of user-defined reports. The compliance integration module may leverage the scaling module 1 to maintain compliance checks across a growing number of transactions and users.

In some implementations, the authentication module may incorporate the concurrent request module to handle multiple authentication processes simultaneously. The user type module may utilize the scaling module to manage role-based access controls for a growing user base efficiently. The onboarding module may leverage the response time module to ensure swift user registration processes. The KYC integration module may utilize the scaling module to handle KYC checks for a large number of users concurrently.

The sanctions screening module may incorporate the concurrent request module to perform multiple screening checks simultaneously. The audit module may leverage the scaling module to maintain comprehensive audit trails across a growing number of system events and transactions.

In some cases, the encryption module may utilize the scaling module to maintain secure data protection across an expanding data set. These scalability and performance considerations may be integrated throughout the Hybrid Asset API Gateway system, enabling efficient operations and supporting growth in user base, transaction volume, and asset diversity.

The system may also incorporate a comprehensive infrastructure and deployment framework to support its operation and maintenance. This framework may include a proposed technology stack, infrastructure components, and DevSecOps practices. The system may utilize Spring Cloud™ (a suite of tools designed to help developers build distributed systems with cloud-native features) as a microservices framework for backend implementation. Spring Cloud™ may provide capabilities for service discovery, configuration management, and distributed tracing, supporting the scalability and resilience of the system.

The system may incorporate PostgreSQL™ as a relational database management system. PostgreSQL™ may handle the storage and retrieval of structured data, supporting the data management needs of various system components. In some implementations, the system may utilize Web3j library for blockchain integration. Web3j may facilitate interactions with Ethereum-compatible blockchain networks, supporting the token minting module and the smart contract manager in their operations. The system may incorporate Infura™ as an Ethereum node provider. Infura™ may offer reliable access to Ethereum networks, supporting the DLT sync module in maintaining synchronization with blockchain-based assets. A network security module may manage network infrastructure and security components, including Virtual Private Clouds (VPCs), subnets, and security groups.

In some implementations, the infrastructure stack may include a compute container module. A compute container module may provide containerization and compute resources, potentially utilizing Elastic Kubernetes Service (EKS) for running containerized microservices. The infrastructure stack may incorporate a storage database module. A storage database module may handle data storage modules, potentially utilizing Amazon RDS™ for PostgreSQL™ database management and Amazon S3™ for object storage.

In some cases, the infrastructure stack may include an identity access module. An identity access module may manage authentication and security aspects, potentially incorporating AWS Secrets Manager™ or HashiCorp Vault™ for secure storage of credentials and secrets. The system may incorporate a routing subsystem. A routing subsystem may handle API management and load balancing, potentially utilizing Application Load Balancer (ALB) for managing HTTPS traffic.

In some implementations, the system may include a monitoring subsystem. A monitoring subsystem may incorporate monitoring and logging capabilities, potentially utilizing CloudWatch™ for baseline monitoring and Prometheus™ with Grafana™ for detailed metrics and dashboards. The system may incorporate an artifact management subsystem. An artifact management subsystem may handle CI/CD pipelines and artifact storage, potentially utilizing GitLab Runners™ for executing CI pipelines and Elastic Container Registry (ECR) for storing Docker images.

In some cases, the system may include a blockchain subsystem. A blockchain subsystem may manage interactions with blockchain networks, potentially incorporating Infura™ as an Ethereum full node provider. The system may incorporate an enhancement module. An enhancement module may include additional components to support system functionality, such as Kafka™ for message brokering and Redis™ for caching. In some implementations, the system may include an infrastructure deployment module. An infrastructure deployment module may specify that services shall be deployed using infrastructure-as-code tools such as Terraform™ or Pulumi™.

The system may incorporate a CI/CD pipeline module. A CI/CD pipeline module may indicate that the platform uses a pipeline with stages for build, test, security scan, and deploy. In some cases, the system may include a source control integration module. A source control integration module may specify that Git-based source control is integrated with CI/CD for automated build triggers.

The system may incorporate an artifact storage module. An artifact storage module may indicate that deployment artifacts are stored in versioned container registries like ECR or Docker Hub™. In some implementations, the system may include a deployment strategy module. A deployment strategy module may specify support for blue-green or canary deployments to maintain high availability. The system may incorporate a credential storage module. A credential storage module may specify that credentials, keys, and secrets must be stored securely using a vault solution.

These infrastructure and deployment considerations may work in conjunction with other system components to support the overall functionality and security of the system. For example, the infrastructure deployment module may support the scaling module in enabling efficient resource allocation. The CI/CD pipeline module may facilitate the implementation of updates to the token minting module and the smart contract manager. In some cases, the source control integration module may support the lifecycle rules module by enabling version control of rule definitions. The artifact storage module may facilitate the deployment of updates to the ramp integration module and the reserve mechanism module. The deployment strategy module may support the uptime module by enabling seamless updates without service interruption. The credential storage module may enhance the security of the authentication module and the KYC integration module.

The system may incorporate user interface modules to support various user interactions and system management functions. These modules may be organized into distinct sections to address different user roles and access points within the system. An interface guidelines module may specify overarching interface guidelines applicable across multiple user interfaces. This module may indicate that user interface and user experience designs are created using design tools such as Figma™, serving as the authoritative source for layout, behavior, and styling specifications. The module may also specify that backend functionalities are provided through APIs according to the agreed API specification.

An admin portal module may define interface modules for platform management by internal teams. This module may include specifications for user and role management capabilities, leveraging the user type module to enforce differentiated access controls. The module may also detail onboarding oversight functions, utilizing the onboarding module to ensure proper user verification processes.

The system may include a web investor module that provide interface modules for the main platform used by investors to manage their investments. This section may specify a dashboard component that provides a portfolio overview and performance charts, potentially utilizing the data exposure module to retrieve and display asset information. The web investor portal module can detail an asset listing functionality. This feature may allow investors to browse and filter investment opportunities, leveraging the asset registration module and the market data integrator to provide comprehensive asset information. The web investor portal module may also include transaction capabilities, enabling investors to invest or pledge funds, and view transaction histories. These functions may utilize the transaction processing module and the settlement module to execute and track financial operations.

The web investor portal module may specify document management features, allowing investors to access and download legal and financial documents. This functionality may leverage the compliance register module to ensure proper document handling and distribution. The web investor portal may also include profile settings, enabling investors to update personal, tax, and banking information, as well as manage notification preferences. These features may utilize the account support module and potentially interact with the KYC integration module and the sanctions screening module to maintain up-to-date user information.

In some implementations, the system may include modules for mobile applications, such as iOS™ and Android™ versions of the investor portal. These mobile interfaces may incorporate core investor features from the web version, adapted for mobile device constraints. Mobile app modules may specify support for biometric login methods, such as Face ID or fingerprint recognition, enhancing the authentication module for mobile users. The mobile app specifications may also include support for push notifications, potentially leveraging the webhook module to deliver timely updates on transaction status or other relevant events.

The user interface modules may interact with various system components to ensure consistent functionality and security across different access points. For example, the authentication module and the encryption module may be applied consistently across all user interfaces to maintain secure access and data protection. The response time module and the concurrent request module may be considered in the design of user interfaces to ensure responsive and efficient user experiences.

The user interface modules may also consider integration with backend modules to support various functionalities. For instance, the order submission interface and the order matching module may be reflected in trading-related interface elements within the web investor portal. The regulatory report generator and the disclosure generator may influence the design of reporting and document access features across both the admin portal and the investor interfaces.

The hybrid asset API gateway system can be implemented using various technical components and approaches to enable its functionality. The system may be deployed on cloud computing infrastructure, utilizing services such as Amazon Web Services (AWS)™, Microsoft Azure™, or Google Cloud Platform™. This cloud-based deployment allows for scalability, high availability, and geographic distribution of system components. The core system architecture may be built using a microservices approach, with each major component (digital depot, digital network, digital register) implemented as separate microservices. These microservices can be containerized using technologies like Docker and orchestrated using Kubernetes for efficient deployment and scaling.

For the digital depot module, a combination of relational and NoSQL™ databases may be employed. PostgreSQ™ L could be used for structured data related to accounts and transactions, while MongoDB might be utilized for more flexible data structures associated with digital wallets and asset representations.

Communication between system components and with external systems may be facilitated through RESTful APIs, utilizing the HTTPS protocol for secure data transmission. For real-time updates and event-driven processes, a message broker like Apache Kafka™ or RabbitMQ™ could be employed, implementing publish-subscribe patterns. The API gateway may be implemented using technologies such as Kong™ or AWS API Gateway™, providing features like request routing, composition, and protocol translation. OAuth 2.0 may be used for authentication and authorization, with JSON Web Tokens (JWTs) for secure information exchange between parties.

For data formats, JSON (JavaScript Object Notation) may be predominantly used for API requests and responses due to its lightweight nature and wide support across programming languages. For more complex data structures or when efficiency is crucial, Protocol Buffers or Apache Avro™ might be employed. The system may implement a comprehensive logging and monitoring solution using the ELK stack (Elasticsearch™, Logstash™, Kibana™) or cloud-native solutions like AWS CloudWatch™. This enables real-time system health monitoring, performance optimization, and anomaly detection.

To ensure data integrity and security, all data at rest may be encrypted using AES-256 encryption, while data in transit is protected using TLS 1.2 or higher. Hardware Security Modules (HSMs) may be utilized for secure key management and cryptographic operations, particularly for managing private keys associated with blockchain interactions.

The system's user interfaces, including the admin portal and investor portals, may be developed as single-page applications (SPAs) using modern JavaScript frameworks such as React™ or Angular™. These interfaces would communicate with the backend services through the API gateway, ensuring a consistent and secure interaction model. For mobile applications, cross-platform frameworks like React Native™ or Flutter™ could be employed to develop both iOS and Android versions, sharing a significant portion of the codebase while providing native-like performance and user experience.

The disclosed implementations also include a novel data model that permits the hybridization of assets. The data structures underpinning the model include:
Asset definitions that store metadata such as asset type, valuation, issuer, and supported formats.
Transaction logs that capture every event (issuance, transfer, redemption, conversion) in immutable, timestamped entries.
Representation layers that define the legal and technical structure of each format (token vs. security), including links to smart contracts, custody accounts, or external ledgers.
Compliance and jurisdictional overlays that constrain representations to only permissible holders, geographies, or transaction conditions.

Together, these structures enable dynamic hybridization, meaning assets can move fluidly between formats based on user needs, regulatory triggers, or market preferences—all while maintaining clear legal and operational continuity.

Specific examples of the various data structures are set forth below.

### User and Compliance Domain Data Structures:

User Object Specification

| Field | Type | Description |
|---|---|---|
| userId | UUID | Unique identifier for the user |
| userType | Enum | END_USER, TECHNICAL_USER, |
| | | BUSINESS_USER |
| email | String | Email address (login ID) |
| fullName | String | Full legal name |
| jurisdiction | String | Country or regulatory region |
| roles | Array | Role identifiers assigned to the user |
| status | String | ACTIVE, PENDING_VERIFICATION, |
| | | BLOCKED |
| createdAt | Timestamp | User registration date |
| metadata | Object | Optional KYC-related or |
| | | system-specific data |

KYCCheck Object Specification

| Field | Type | Description |
|---|---|---|
| checkId | UUID | Unique ID for the KYC request |
| userId | UUID | Associated user ID |
| provider | String | Verification service (e.g., SumSub) |
| status | String | INITIATED, IN_REVIEW, |
| | | VERIFIED, FAILED |
| resultDetails | Object | Provider-specific structured result |
| startedAt | Timestamp | Time KYC process was started |
| completedAt | Timestamp | Completion timestamp, if available |

### Asset Domain Data Structures:

Asset Object Specification

| Field | Type | Description |
|---|---|---|
| assetId | UUID | Unique identifier for the asset (generated on |
| | | registration) |
| assetName | String | Name/title of the security (e.g., “Fund A Series B”) |
| assetType | Enum | Type of asset |
| | | (e.g., PRIVATE_EQUITY, BOND, REAL_ESTATE, FUND) |
| assetClass | Enum | High-level classification (e.g., EQUITY, DEBT, HYBRID) |
| issuerId | UUID | Reference to legal entity issuing the asset |
| jurisdiction | String | Legal jurisdiction where the asset is issued |
| | | (e.g., US, EU, UAE) |
| securityIdentifier | String | Optional ISIN, CUSIP, or internal reference |
| nominalValue | Decimal | Total value of the asset (e.g., $5,000,000) |
| currency | String | Currency code (e.g., USD, EUR) |
| issueDate | Date | Date when the asset is issued or becomes effective |
| maturityDate | Date | (Optional) For fixed income assets |
| distributionPolicy | Enum | REINVEST, CASH_DIVIDEND, FIXED_COUPON, NONE |
| transferRestrictions | Boolean | Indicates whether transfers are restricted |
| representationOptions | Array[Enum] | Supported ownership types: SECURITY, TOKEN, or both |
| regulatoryTags | Array[String] | Tags such |
| | | as REG_D, MiFID_PROFESSIONAL, QIB, EXEMPT_OFFERING |
| metadata | Object | Flexible JSON for storing issuer-specific data, |
| | | documents, notes |

Account Object Specification

| Field | Type | Description |
|---|---|---|
| accountId | UUID | Unique identifier for the account |
| accountType | Enum | Type of account: SECURITIES, WALLET, ESCROW |
| ownerId | UUID | Reference to the user, investor, or entity that owns the account |
| currency | String | ISO currency code (e.g., USD, EUR) |
| balance | Decimal | Current account balance |
| balanceOnHold | Decimal | Amount currently reserved/locked in escrow or pending |
| | | settlement |
| linkedAssetId | UUID | (Optional) ID of the asset related to the account |
| status | String | Account status: ACTIVE, FROZEN, CLOSED |
| createdAt | Timestamp | Account creation time |
| metadata | Object | Optional metadata for tagging or integration-specific fields |

Settlement Object Specification

| Field | Type | Description |
|---|---|---|
| settlementId | UUID | Unique identifier for the settlement |
| | | instruction |
| buyerAccountId | UUID | Receiving account for the asset or token |
| sellerAccountId | UUID | Sending account for the asset or token |
| amount | Decimal | Amount of asset to be settled |
| currency | String | Currency used for payment (e.g., USD) |
| pricePerUnit | Decimal | Agreed price per unit (optional for |
| | | full transfer) |
| settlementType | Enum | T0, T1, T2, etc. |
| mode | Enum | DVP, FREE_OF_PAYMENT |
| status | String | PENDING, SETTLED, FAILED |
| initiatedBy | String | User or system triggering the settlement |
| timestamp | Timestamp | Time of instruction submission |

### Digital Network Domain Data Structures:

Token Object Specification

| Field | Type | Description |
|---|---|---|
| tokenId | UUID | Unique identifier for the tokenized asset |
| linkedAssetId | UUID | Reference to the underlying asset |
| blockchain | String | Blockchain network used for token |
| | | issuance (e.g., Ethereum, Polygon) |
| contractAddress | String | Smart contract address for the token |
| tokenStandard | Enum | Token standard (e.g., ERC-20, |
| | | ERC-1400) |
| supply | Decimal | Total number of tokens issued |
| reserveAccountId | UUID | ID of the Digital Depot account holding |
| | | the backing reserve |
| reserveAmount | Decimal | Amount of the reserve linked to |
| | | the token |
| currency | String | Currency of the reserve (e.g., USD) |
| status | String | Token status: ACTIVE, PAUSED, |
| | | EXPIRED |
| createdAt | Timestamp | Token creation time |
| metadata | Object | Optional metadata for customization or |
| | | legal references |

RampTransaction Object Specification

| Field | Type | Description |
|---|---|---|
| transactionId | UUID | Unique identifier for the ramp transaction |
| type | Enum | ON_RAMP or OFF_PAMP |
| amount | Decimal | Amount being converted |
| currencyFrom | String | Source currency (e.g., BTC, USD) |
| currencyTo | String | Target currency (e.g., USD, ETH) |
| walletAddress | String | Crypto address (for ON ramp) |
| bankAccountId | String | Bank account reference (for OFF ramp) |
| status | String | PENDING, IN_PROGRESS, |
| | | COMPLETED, FAILED |
| provider | String | Name of the integrated ramp provider |
| timestamp | Timestamp | Creation time of the ramp transaction |

### Digital Register Domain Data Structures:

RegisterEvent Object Specification

| Field | Type | Description |
|---|---|---|
| eventId | UUID | Unique identifier for the event |
| eventType | Enum | Type of event (e.g., ISSUANCE, |
| | | TRANSFER, |
| | | CORPORATE_ACTION, |
| | | AUDIT_LOG, ENFORCEMENT |
| assetId | UUID | Related asset ID |
| accountId | UUID | Related account involved |
| | | (if applicable) |
| timestamp | DateTime | Time of event occurrence |
| details | Object | Flexible JSON object for structured |
| | | event data |
| initiatedBy | String | User or system ID that triggered |
| | | the event |
| linkedTransactionID | UUID | (Optional) Related transaction ID |
| syncedToDLT | Boolean | Whether this event has been synced |
| | | to a blockchain |
| syncDetails | Object | Optional sync status, blockchain |
| | | ID, transaction hash |

### Trading Domain Data Structures:

Order Object Specification

| Field | Type | Description |
|---|---|---|
| orderId | UUID | Unique identifier for the order |
| assetId | UUID | ID of the asset being traded |
| accountId | UUID | Investor account placing the order |
| orderType | Enum | BUY, SELL |
| unitCount | Integer | Number of units to buy or sell |
| pricePerUnit | Decimal | Price per unit (if applicable) |
| status | String | OPEN, PARTIALLY_MATCHED, |
| | | MATCHED, CANCELLED |
| createdAt | Timestamp | Time the order was placed |

Subscription Object Specification

| Field | Type | Description |
|---|---|---|
| subscriptionId | UUID | Unique identifier for the |
| | | subscription match |
| buyOrderId | UUID | Buy-side order ID |
| sellOrderId | UUID | Sell-side order ID |
| matchedUnits | Integer | Number of units matched |
| matchPrice | Decimal | Final agreed unit price |
| status | String | PENDING_SETTLEMENT, |
| | | SETTLED, FAILED |
| matchedAt | Timestamp | Time of match execution |

### Reporting Domain Data Structures:

ReportRequest Object Specification

| Field | Type | Description |
|---|---|---|
| reportId | UUID | Unique identifier for the report |
| reportType | Euum | REGULATORY, |
| | | INVESTOR_DISCLOSURE, CUSTOM |
| format | Enum | PDF, CSV, JSON |
| parameters | Object | Optional filters: accountId, dateRange, |
| | | assetId, etc. |
| status | String | QUEUED, GENERATING, COMPLETED, |
| | | FAILED |
| scheduled | Boolean | Whether this report is generated on a |
| | | schedule |
| schedule | String | (Optional) Cron or interval expression |
| createdAt | Timestamp | Time the report was requested |
| downloadUrl | String | Link to retrieve generated report (if ready) |

### API Domain Data Structures:

API Gateway Configuration Object

| Field | Type | Description |
|---|---|---|
| gatewayId | UUID | Unique identifier for the gateway instance |
| tenantId | UUID | Tenant context for multi-tenancy |
| rateLimit | Integer | Max allowed requests per time window |
| | | (e.g., per minute) |
| authProvider | Enum | KEYCLOAK, GOOGLE, |
| | | AZURE_AD etc. |
| accessControl | Object | JSON map of role-to-scope mapping rules |
| webhooksEnabled | Boolean | Whether webhook notifications |
| | | are enabled |
| allowedOrigins | Array | CORS whitelist of external clients |

The data model and architecture described above provide for the definition and management of “hybrid assets” i.e., assets that combine properties of both cryptographic tokens and traditional securities. As discussed above, this hybrid approach allows for flexible representation of ownership units while maintaining a unified backend structure. The core of the data model is built around the asset object, which contains metadata such as asset class, attributes, economic value, and legal structure. The asset object serves as the foundation for creating hybrid representations of assets. When an issuer onboards an asset, they define these properties through the API gateway, resulting in the creation of a unique asset identifier stored in the digital register.

The system's architecture enables the issuer to choose between representing ownership units as traditional securities or blockchain-based digital tokens. This flexibility is achieved through the interaction of digital depot module 110, the digital network module, and the digital register module 120.

The process of defining and managing hybrid assets can include the following steps:
1. Asset Registration: The issuer defines asset metadata via API endpoints, creating a unique identifier in the digital register.
2. Fractionalization: The issuer invokes fractionalization APIs to define ownership units, specifying whether they will be represented as traditional securities or digital tokens.
3. Issuance and Allocation: The Digital Depot module handles the creation of securities accounts or digital wallets, registration of ownership units, and generation of transactional records.
4. Blockchain Registration (for tokenized assets): The Digital Network module interacts with the chosen distributed ledger to mint tokens, deploy smart contracts, and register relevant metadata.
5. Ongoing Management: The system facilitates asset lifecycle events such as transfers, corporate actions, and compliance workflows through the interaction of all three modules.

### Example 1: Tokenized Real Estate Fund

Creation: An issuer registers a real estate fund as an asset, defining properties such as total value, number of properties, and expected yield. They choose to represent ownership units as digital tokens. The system creates a unique asset identifier and prepares for token issuance.

Management: The Digital Network module deploys a smart contract on the selected blockchain, minting tokens representing fractional ownership. When an investor purchases tokens, the Digital Depot module creates a digital wallet and allocates the tokens. The Digital Register records the issuance event, ownership transfer, and maintains an immutable history of all transactions. If the fund distributes dividends, the smart contract automates the process, with the Digital Depot handling fiat settlements and the Digital Register recording the events.

### Example 2: Hybrid Bond Issuance

Creation: A corporate issuer registers a bond offering, specifying parameters such as face value, coupon rate, and maturity date. They opt for a hybrid representation, allowing investors to hold the bond as either a traditional security or a digital token. The system creates the asset record and prepares dual issuance channels.

Management: For traditional securities, the Digital Depot module manages entries in securities accounts. For tokenized representations, the Digital Network module issues corresponding tokens on a blockchain. When an investor converts between formats, the system updates records in both the securities accounts and the blockchain, with the Digital Register maintaining a comprehensive audit trail. Coupon payments and redemption at maturity are handled through smart contracts for tokenized holdings, while traditional processes manage payments for securities account holders. The system ensures that the total number of outstanding units remains constant across both representations, maintaining the integrity of the hybrid asset.

This hybrid asset management system leverages the strengths of both traditional financial infrastructure and blockchain technology. It provides issuers with unprecedented flexibility in asset representation while ensuring regulatory compliance, operational efficiency, and seamless interoperability between traditional and digital asset ecosystems.

As illustrated in FIG. 3, the operation of the system can follow a structured, modular process flow that enables issuers to fractionalize, represent, and allocate ownership of assets—whether in the form of traditional securities or digital tokens—through a secure, scalable, and blockchain-agnostic infrastructure.

### Asset Onboarding and Definition

The process begins with the onboarding of the underlying asset by the issuer. At 1, the issuer defines asset metadata, such as the asset class, attributes, economic value, and legal structure via designated API endpoints exposed by the Gateway. Asset types may include, but are not limited to, tangible assets (e.g., real estate, commodities, artwork, luxury goods, and equipment) and intangible assets (e.g., investment funds, intellectual property rights, digital art, carbon credits, and in-game assets). The asset onboarding operation results, at 2, in the creation of a unique asset identifier which is stored in digital register 110, along with the metadata, and used to reference and manage the asset throughout its lifecycle.

### Fractionalization and Representation Structuring

Following asset registration, the issuer invokes fractionalization APIs, allowing the definition of ownership units. Each unit represents a standardized share of the underlying asset, which can be issued either as:
A traditional security, registered within a securities account infrastructure
A digital token, issued and maintained via a distributed ledger system

The representation type is selected and executed via configurable parameters, enabling the issuer to offer dual-format ownership while maintaining a unified backend structure. The 1:1 asset backing mechanism ensures each issued unit corresponds precisely to an allocated value of the underlying asset.

### 3. Representation Issuance and Allocation

Once the ownership structure has been defined, the Digital Depot module handles the issuance and allocation process. This includes:
Creation of the securities account or digital wallet structure
Registration of ownership units into the appropriate account or wallet
Escrow account configuration (if required Just as reminder
Generation of a complete transactional record accessible via API

At this stage, the issuer allocates ownership units to the designated investor account or wallet address. These allocations are executed programmatically through the issuer's own interface, using the API Gateway as a backend infrastructure layer. The Gateway does not interface with the investor directly.

In cases where the investor elects to purchase ownership units using cryptocurrency, the system initiates an integrated crypto-to-fiat conversion process. Through the Digital Network module, the cryptocurrency payment is routed to a connected third-party on- and off-ramp service provider. The provider executes a real-time conversion, and the resulting fiat currency is automatically credited to the issuer's escrow or settlement account within the Digital Depot infrastructure. This mechanism ensures that all ownership records and asset settlements are finalized in fiat currency, thereby maintaining operational compatibility with regulatory and accounting frameworks.

### 4. Blockchain Registration and Audit Trail

If the representation is issued in tokenized form, the Digital Network module interacts with the designated distributed ledger infrastructure to perform:
Token minting and smart contract deployment
Digital transfer of ownership units
Registration of relevant metadata and asset linkage
Integration of token lifecycle rules, including lockups or transfer restrictions (if defined by the issuer)

Concurrently, the Digital Register module maintains an immutable record of all issuance events, ownership changes, and corporate actions, providing full auditability and legal traceability. This register may optionally synchronize with public blockchains or operate in a permissioned ledger environment, depending on issuer preference and regulatory context.

### 5. Account Holding and Custody

Upon completion of the issuance process, the investor holds the respective asset unit in either:
A securities account (in the case of traditional representation)
A digital wallet (in the case of tokenized representation)

Custodial services, wallet interfaces, and end-user account management are provided by the issuer or its appointed service providers. The API Gateway does not provide custody or interface with the investor; rather, it enables the issuer to control account logic, ownership records, and asset servicing infrastructure via secure APIs.

### 6. Ongoing Asset Management and Lifecycle Events

Post-issuance, the issuer may utilize additional API functionalities to manage asset lifecycle events, including:
Corporate actions (e.g., dividend distributions, asset performance updates, rights issues)
Asset status updates (e.g., revaluations, write-downs)
Escrow releases
Event-triggered compliance workflows

These functionalities are facilitated through Digital Depot and Digital Register modules, with transactional and historical data accessible to the issuer via the Gateway's secure API layer.

FIG. 3 illustrates an example of a step-by-step operational sequence for a token-based investment utilizing the Hybrid Asset API Gateway infrastructure. The diagram delineates the interactions between the key actors and technical modules, namely: the Investor, the Issuer, the Primary Market, the Digital Depot, the Digital Register, and Digital Network. The investor, issuer, and primary market can interact with one another in a conventional manner as shown in FIG. 3. The investor can access the issuer's web application to subscribe to an asset offering, such as a hedge fund. The investor is prompted to undergo compliance procedures (e.g., Know Your Customer (KYC) and Anti-Money Laundering (AML)), which can be fully managed by the issuer. Subsequently, the investor selects the desired format of ownership—either traditional security or digital token—during the subscription process. The investor also selects the preferred payment method, choosing between fiat currency or cryptocurrency.

In parallel, the issuer configures the investment product through asset metadata registration via the API Gateway, at 1. The digital register module 130 records the product and metadata at 2, and initiates asset tokenization configuration using the digital network module 120 at 3. Smart contract parameters are defined at 4 but not deployed until investment funds are secured.

If payment is made in cryptocurrency, the funds are routed through on- and off-ramp integration of digital network module 120 whereby the digital assets are converted to fiat currency. The resulting fiat proceeds are credited to the issuer's escrow account within the digital depot module 110 at 6. Alternatively, if fiat is used directly, the investor's payment flows into the same escrow account without conversion at 7.

Investment orders are processed through the primary market, where they are recorded in the order book, matched, and settled accordingly. The escrow account in the digital depot module 110 may receive both fiat and securities proceeds, depending on the transaction configuration.

Upon confirmed settlement, token issuance is executed via digital network module 120, at 8, and the digital ownership units are transferred to the investor's digital wallet at 9. At 10, the digital register module 110 records critical lifecycle events—such as fiat receipt, securities allocation, and token distribution—for legal and audit purposes. These records ensure immutability, compliance traceability, and legal integrity across all asset representations. The process concludes with the investor viewing their holdings through the issuer's front-end application, either in a securities account or as tokenized units in a digital wallet, depending on the chosen holding format.

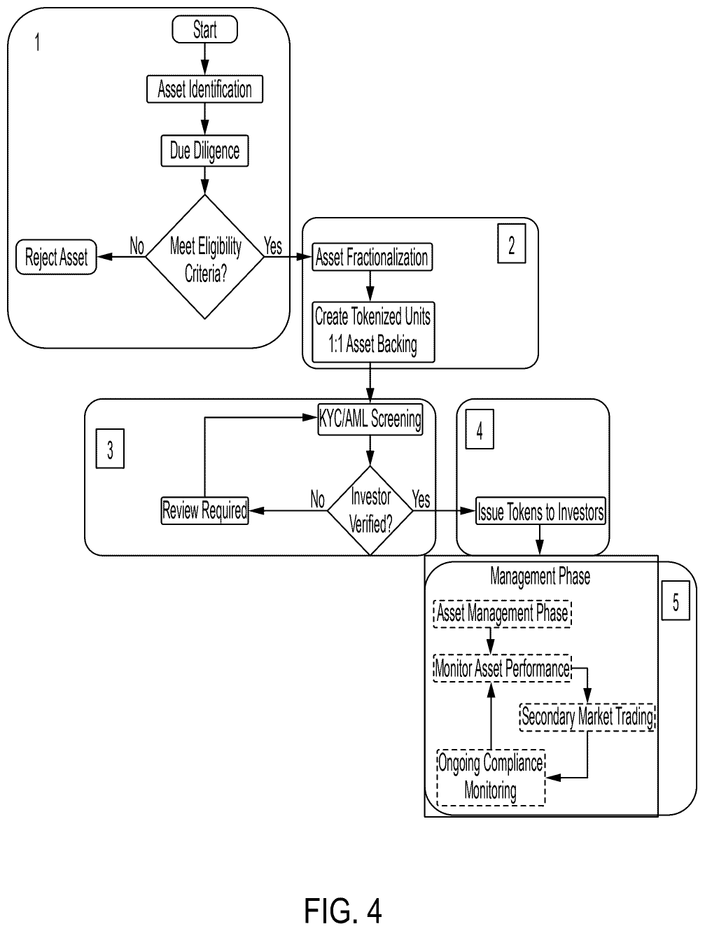

FIG. 4 illustrates an example focusing on an asset tokenization workflow in accordance with disclosed implementation. At 1, conventional processes of defining an asset are accomplished, including asset identification, due diligence and eligibility determination based on various criteria. At 2, The asset can be fractionalized and tokenized units are created. At 3, conventional investor onboarding processes are accomplished. At 4, the tokens are issued to investors. At 5, the system captures various information over the lifecycle of the asset. The information can include asset registration information with metadata and documentation, market intelligence NAV and valuation reports for private assets, historical and live asset data. Specifically, as shown in FIG. 4. The following are monitored: asset management, asset performance, secondary market activity, and compliance issues. Further, as noted above, the system can generate the following information: predefined regulatory reports, scheduled or event-triggered reports investor-level disclosures (e.g., tax, dividends), and .custom reports using dynamic asset and market data.

The system disclosed herein acts as a backend infrastructure solution, enabling tokenization, settlement, asset handling, and register management without directly engaging in compliance, distribution, or end-user interfaces. The system, as disclosed herein, is a modular and blockchain-agnostic infrastructure designed to facilitate asset issuance, ownership representation, and lifecycle management across a wide range of industry verticals. The system is designed with a robust and modular technical framework to support regulatory compliance integration and enterprise-grade security standards across global financial markets. While the responsibility for legal and regulatory compliance, including Know Your Customer (KYC) and Anti-Money Laundering (AML) procedures, can remain with the issuer or integrator of the system, the infrastructure is purpose-built to facilitate seamless interoperability with jurisdiction-specific modules and compliance modules.

The module driven architecture supports integration with external compliance systems and frameworks, enabling issuer-side adherence to relevant regulations such as the Markets in Crypto-Assets Regulation (MiCA) in the European Union, the Securities and Exchange Commission (SEC) modules in the United States, and similar supervisory regimes in other jurisdictions.

The infrastructure provides standardized APIs and modular data structures that allow issuers to connect their existing KYC/AML tools, investor onboarding workflows, reporting engines, and tax compliance modules. It further supports configuration of asset representations in compliance with local securities classifications, offering flexible deployment across regulated and unregulated environments.

Additionally, the infrastructure supports cross-border deployment scenarios, including customizable jurisdictional tagging, smart contract logic for geographic restrictions, and dynamic asset categorization mechanisms. This ensures that asset issuance, ownership recording, and settlement processes can be aligned with diverse and evolving regulatory landscapes.

The system incorporates multi-layered security protocols to safeguard asset integrity, user data, and system operations. The module driven architecture includes:
End-to-end encryption of data in transit and at rest.
Role-based access control and multi-factor authentication for all API endpoints.
API throttling and rate-limiting to prevent abuse or denial-of-service attacks.
Escrow account integrity verification and transaction sequencing mechanisms.
Optional integration with quantum-resistant cryptographic modules to ensure long-term security resilience.

Blockchain-based components, including token issuance and lifecycle event recording, contribute to the system's immutable audit trails. The Digital Register module captures transaction logs, issuance records, and asset metadata in a verifiable format, supporting auditability and evidentiary standards.

The infrastructure further allows issuers to embed validation logic within smart contracts, enabling automated enforcement of compliance conditions, transfer restrictions, and lifecycle triggers without manual intervention. These technical safeguards support operational robustness and reduce the likelihood of administrative error or fraud.

The system of the present disclosure offers several significant technical advantages. The modular architecture, comprising the digital depot, digital network, and digital register components, allows for independent deployment and upgrading of each module without affecting the functionality of others. This design enhances the system's adaptability to evolving market modules and regulatory landscapes. Additionally, the system's ability to represent ownership units as either traditional securities or blockchain-based digital tokens provides unprecedented flexibility, catering to diverse investor preferences and regulatory frameworks. The integration of multiple distributed ledger technologies further expands this flexibility, allowing issuers to select the most suitable blockchain network for their specific needs. Moreover, the incorporation of smart contract functionality enables automated enforcement of issuer-defined rules, including lock-up periods and transfer restrictions, enhancing compliance and reducing manual oversight. The system's immutable record-keeping capabilities, facilitated by the digital register module, ensure transparency and auditability across all asset lifecycle events, supporting regulatory compliance and investor trust. Furthermore, the integrated routing mechanism for cryptocurrency-to-fiat conversion streamlines the investment process, bridging the gap between traditional and digital asset ecosystems. Collectively, these technical advantages position the hybrid asset API gateway as a comprehensive, flexible, and robust solution for managing fractionalized ownership of diverse asset classes in both traditional and tokenized formats.

The following non-limiting use cases demonstrate the industrial applicability of the invention, with each scenario illustrating the operative roles of the respective system components.
1. Investment Funds and Capital Markets: The invention enables the digitization and fractionalization of ownership interests in hedge funds, venture capital vehicles, private equity structures, and alternative investment products. Issuers can utilize the infrastructure to offer participation units to investors in either traditional security form or as tokenized representations, while retaining full control over compliance integration, issuance parameters, and investor management.
2. Real Estate and Tangible Asset Markets: The system supports tokenization of fractional interests in physical assets, including commercial and residential real estate, industrial equipment, commodities, luxury goods, and artwork. The infrastructure enables asset owners or managers to structure divisible ownership units, execute issuance via smart contracts, and provide investors with custody through digital wallets or securities accounts.
3. Intellectual Property and Licensing Revenues: The invention may be utilized for the structured issuance of revenue rights or equity-like participation in intellectual property assets, including patents, copyrights, trademarks, and licensing agreements. Tokenization of such rights allows for enhanced liquidity, improved capital access, and transparent distribution mechanisms for royalties or proceeds.
4. Carbon Credits and Sustainability Instruments: The infrastructure is equally applicable to the tokenization of sustainability-linked assets, including carbon credits, renewable energy certificates, and emission allowances. This supports both voluntary and regulated market structures and enables issuers to structure, allocate, and settle such instruments via a standardized digital infrastructure.
5. Digital Art, Collectibles, and Metaverse Assets: The invention further extends to digital-native asset categories, including non-fungible tokens (NFTs), in-game items, virtual land plots, and digital collectibles. Through Digital Network, issuers may execute smart contract-based issuance, while the Digital Register ensures immutable provenance, transfer history, and compliance anchoring.
6. Small and Medium Enterprise (SME) Financing: Small businesses may utilize the API Gateway to fractionalize ownership in income-generating contracts or revenue streams (e.g., subscription models, recurring receivables), thereby enabling direct investor participation. This allows for democratized access to business capital and serves as an alternative financing mechanism for SMEs without reliance on centralized financial intermediaries.
7. Public Infrastructure and Civic Financing: Government entities and municipal authorities may deploy the system to structure investment-grade participation in public infrastructure projects such as toll roads, utilities, public transportation systems, and renewable energy facilities. Investors may be issued fractional interests in revenue participation instruments, with lifecycle events and audit trails anchored via the Digital Register.
8. Financial Institutions and Infrastructure Providers: The system may be licensed and integrated by banks, custodians, investment platforms, and other financial infrastructure providers seeking to digitize their asset issuance, custody, and investor servicing processes. Through white-label integration of the API Gateway and its modules (Digital Depot, Digital Network, and Digital Register), such institutions may offer customized digital asset lifecycle management under their own operational stack.

A number of implementations have been described. Nevertheless, it will be understood that various modifications may be made without departing from the spirit and scope of the disclosure. Accordingly, other implementations are within the scope of the following claims.

1. A hybrid asset API gateway system, comprising:
standardized application programming interface (API) gateway configured to integrate with asset issuer systems and expose endpoints for asset onboarding, ownership unit creation, representation selection, transaction execution, escrow management, and record retrieval;
a digital depot module configured to manage asset accounts, digital wallets, and fiat-based transaction records, wherein the digital depot module includes an asset register module configured to store fiat currency records, cryptocurrency records, cryptographic tokens, and traditional securities information;
a digital network module configured to create digital tokens representing ownership units of assets and to deploy such tokens on a distributed ledger network, wherein the digital network module includes a token minting module for creating digital tokens and a smart contract manager for deploying and managing smart contracts on selected blockchain networks;
a digital register module configured to maintain immutable records of asset lifecycle events, wherein the digital register module includes a record keeper module for recording and storing all asset issuance events, ownership transfers, and corporate actions;
wherein the system is configured to allow an issuer to select between representing ownership units as traditional securities or blockchain-based digital tokens, and wherein each ownership unit is backed on a one-to-one basis by the value of an underlying asset.

2. The system of claim 1, wherein the digital network module is configured to interface with multiple distributed ledger technologies, and selection of a target blockchain network is configurable by the issuer, and wherein the digital network module includes a DLT sync module for synchronization with various distributed ledger technologies.

3. The system of claim 1, further comprising an integrated routing mechanism configured to transmit investor cryptocurrency payments to a third-party on- and off-ramp service provider for conversion into fiat currency, wherein the converted fiat is programmatically credited to an issuer-designated settlement account, and wherein the digital network module includes a ramp integration module to facilitate the conversion between cryptocurrencies and fiat currencies.

4. The system of claim 1, wherein the digital network module includes a smart contract engine configured to enforce issuer-defined rules, including lock-up periods, transfer restrictions, and jurisdictional limitations, and wherein the smart contract engine is configured to encode the rules and logic governing the behavior of the digital tokens.

5. The system of claim 1, wherein the digital register module is operable to record all asset issuance events, ownership transfers, and corporate actions on a distributed ledger in an immutable and auditable format, and wherein the digital register module further includes a compliance register module configured to handle the registration and tracking of regulatory compliance events, corporate actions, and legally significant occurrences throughout an asset's lifecycle.

6. The system of claim 1, wherein each module is independently deployable and upgradable without affecting the functionality of the other modules, and wherein the system implements a microservices architecture with each major component implemented as separate microservices that can be containerized and orchestrated using Kubernetes for efficient deployment and scaling.

7. The system of claim 1, further comprising an authentication module configured to enforce OAuth 2.0 authentication and role-based access control on all API endpoints, and wherein the system includes an encryption module configured to encrypt all data in transit and at rest using AES-256 or equivalent encryption standards.

8. A computer-implemented method for managing hybrid asset representations, comprising:
receiving, via an API gateway, an asset registration request from an issuer, wherein the asset registration request includes asset metadata comprising asset class, attributes, economic value, and legal structure;
creating, in response to the asset registration request, a digital representation of an asset and a unique asset identifier;
storing the digital representation and the unique asset identifier in a digital depot module, wherein the digital depot module maintains a transactional ledger that records every asset-related event as an immutable transaction;
receiving, via the API gateway, a request to issue ownership units of the asset;
determining, based on issuer input, whether to represent the ownership units as traditional securities or blockchain-based digital tokens;
creating the ownership units in the selected representation format; and
recording the issuance of the ownership units in an immutable digital register, wherein balances for accounts or wallets are computed on demand by aggregating historical transactions to ensure all balances are fully auditable and backed by verifiable events.

9. The method of claim 8, further comprising:
receiving, via the API gateway, a request to transfer ownership units;
verifying the transfer request against smart contract rules enforced by a digital network module; and
upon successful verification, updating ownership records in the digital depot module and recording the transfer in the immutable digital register, wherein the digital register maintains a comprehensive record of all changes in asset representation.

10. The method of claim 9, wherein the smart contract rules include lock-up periods, transfer restrictions, and jurisdictional limitations configurable by the issuer, and wherein the smart contract rules are encoded within smart contracts managed by a smart contract manager of the digital network module.

11. The method of claim 8, further comprising:
receiving, via the API gateway, a request to convert ownership units between traditional securities and blockchain-based digital tokens;
executing the conversion by updating representations in the digital depot module and recording the conversion event in the immutable digital register; and
maintaining a unified backend infrastructure during the conversion process while ensuring that the total number of outstanding units remains constant across both representations.

12. The method of claim 8, wherein creating the ownership units in the selected representation format comprises:
for traditional securities, generating entries in a securities account within the digital depot module; and
for blockchain-based digital tokens, deploying a token contract on a distributed ledger network via the digital network module, wherein the token contract includes issuer-defined rules for lock-up periods, transfer restrictions, and jurisdictional limitations.

13. The method of claim 12, wherein the distributed ledger network is selectable by the issuer from multiple supported blockchain technologies, and wherein the digital network module is configured to support various blockchain platforms through a blockchain subsystem that manages interactions with blockchain networks.

14. The method of claim 8, further comprising:
generating, based on data from the digital depot module and the immutable digital register, regulatory compliance reports using a reporting module that includes a regulatory report generator for creating predefined regulatory reports based on data aggregated from multiple system components; and
providing the regulatory compliance reports to authorized parties via secure API endpoints protected by OAuth 2.0 authentication and role-based access control.

15. The method of claim 8, further comprising:
receiving, via the API gateway, investor cryptocurrency payments for purchasing ownership units;
routing the cryptocurrency payments through an integrated routing mechanism to a third-party on- and off-ramp service provider;
converting the cryptocurrency payments to fiat currency through the service provider; and
crediting the converted fiat currency to an issuer-designated settlement account within the digital depot infrastructure.

16. The method of claim 8, further comprising:
managing asset lifecycle events through the API gateway, including corporate actions, asset status updates, escrow releases, and event-triggered compliance workflows; and
recording each lifecycle event in the immutable digital register to maintain a transparent and auditable history of all asset-related activities.

17. A non-transitory computer-readable medium storing instructions that, when executed by a processor, cause the processor to perform operations for facilitating hybrid asset management, the operations comprising:
receiving, via a standardized API gateway, an asset registration request from an issuer;
creating a digital representation of an asset with a unique asset identifier;
storing the digital representation in a digital depot module that implements a transactional ledger model;
determining, based on issuer input, whether to represent ownership units as traditional securities or blockchain-based digital tokens;
creating the ownership units in the selected representation format through either securities account entries or token contract deployment; and
recording all asset lifecycle events in an immutable digital register that maintains a comprehensive audit trail supporting compliance checks, regulatory reporting, and integration with downstream services.

18. The non-transitory computer-readable medium of claim 17, wherein the operations further comprise:
implementing a scaling module that supports horizontal scaling in Kubernetes;
configuring the system to handle a minimum of 1,000 concurrent requests; and
ensuring that APIs respond within a predetermined time of 500 ms for 95% of requests under normal load conditions.

19. The non-transitory computer-readable medium of claim 17, wherein the operations further comprise:
implementing a reserve mechanism module configured to ensure that tokenized securities are backed by corresponding assets;
maintaining the integrity of the tokenization process by verifying that the total number of outstanding units remains constant across both traditional and tokenized representations; and
providing a settlement module that supports T+0 settlement and atomic delivery-versus-payment (DvP) for tokenized assets.

20. The non-transitory computer-readable medium of claim 17, wherein the operations further comprise:
implementing a user and compliance module that manages user identities, access control, and regulatory compliance;
integrating with Know Your Customer (KYC) provider services to perform identity verification and due diligence checks; and
implementing a sanctions screening module that handles sanction list checks and Politically Exposed Person (PEP) screenings to ensure compliance with international regulations.
